(19) United States
(12) Patent Application Publication
(10) Pub. No.: US 2015/0002297 A1
(43) Pub. Date: Jan. 1, 2015

(54) Method and System for Managing Metadata from Bodily Fluid Analyzers

(71) Applicants: Richard C. FUISZ, Beverly Hills, CA (US); Joseph M. FUISZ, Surfside, FL (US)

(72) Inventors: Richard C. FUISZ, Beverly Hills, CA (US); Joseph M. FUISZ, Surfside, FL (US)

(21) Appl. No.: 13/927,136

(22) Filed: Jun. 26, 2013

(51) Int. Cl. G08B 21/02

(52) U.S. Cl. CPC G08B 21/02
USPC 340/573.1

(57) ABSTRACT

A method and system are provided for electronically delivering to a caregiver analytical result and alert data concerning a breach or non breach of an alert limit for an analyte. The method includes providing a medical analyzer with at least one threshold value for the at least one analyte to be sensed by the medical analyzer, sensing the analyte level; and, if the sensed analyte level is beyond the threshold value, electronically sending data to the caregiver, the data comprising an indication of the analyte and the limits set by the caregiver, a breach of the threshold value, the degree of the breach on the basis of an amount over or under the threshold value, a time interval between breaches whether fixed or rolling, a total number of breaches in a given time cycle, and the total number of tests in the time period.

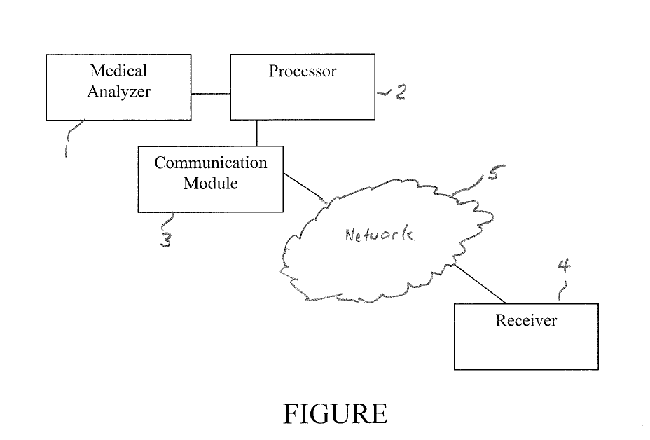

### BACKGROUND OF THE INVENTION

Personal glucose monitors enjoy widespread commercial use. Because the data generated by such products is both limited in scope (i.e. glucose data), and subject to relatively straightforward management by monitor users (diabetics typically have a pretty good understanding of how and what to do with glucose level data), there has been little need to develop new methods and systems to handle such data.

Similarly, episodic blood testing as currently practiced (e.g. a SMAC or sequential multiple analysis comprehensive blood test) yields limited episodic data that is readily interpreted without the need for advanced methods and systems to handle such data. The data is usually generated in a lab and sent as a lab report to the physician. The volume of data is manageable by the Caregiver.

However, there it is possible that we will ultimately see the commercialization of bodily fluid analyzers that are used at frequent intervals (and potentially nearly constant real-time data) and measure a potentially broad spectrum of analytes. Many companies are working to develop such devices, like BioDirection, Theranos, academics (e.g. a team of scientists at Ecole Polytechnique Fédérale de Lausanne in Switzerland have developed a small medical implant to monitor critical chemicals in the blood designed to tell your smartphone when you are about to have a heart attack; see, http ://www.extremetech.com/computing/151134-worlds-smallest-blood-monitoring-implant-talks-to-a-smartphone-but-whose), venture capitalists like the Mike Lazardis' new Quantum Valley Fund and more established companies like Roche and purported new companies like Biozoom in Germany and California.

Similarly, breath-based diagnostics, which potentially enables data sampling without virtually no invasive sampling activity, has the potential to proliferate and provide increasing data streams. Breath is a body fluid.

The present inventors previously addressed the programming and setting of bodily fluid analyzer alert levels in U.S. Pat. No. 7,824,612 (“Bodily fluid analyzer, and system including same and method for programming same”), the contents of which are hereby incorporated by reference as though fully set forth herein. They have also filed a patent relating to breath-based diagnostics (U.S. patent application Ser. No. 13/423,527) the contents of which are hereby incorporated by reference as though fully set forth herein.

Constructively engaging the large amounts of data that will emanate from such devices will be challenging. How such large amounts of data can be constructively engaged by medical practitioners remains an unanswered question. Moreover, the testing of analytes is unlikely to be without direct costs, particularly where reagents are employed as well as various devices. Thus, there will be optimal ranges of testing frequency, balancing marginal cost of test with marginal benefit, all dependent on the ability of the caregiver to make meaningful decisions based on the data at his or her disposal. Thus, management of data from such devices desirably interplays with the management of the devices themselves (in terms of analytes tested, testing frequency, clinical relevance, etc).

### SUMMARY OF THE INVENTION

The present invention relates to a method for electronically delivering to a caregiver analytical alert data concerning a breach or non breach of an alert limit for an analyte. The method includes providing a medical analyzer with at least one threshold value for the at least one analyte to be sensed by the medical analyzer, sensing the analyte level; and, if the sensed analyte level is beyond the threshold value, electronically sending data to the caregiver, the data comprising an indication of the analyte and the limits set by the caregiver, a breach of the threshold value, the degree of the breach on the basis of an amount over or under the threshold value, a time interval between breaches whether fixed or rolling, a total number of breaches in a given time cycle, and the total number of tests in the time period.

The present invention also relates to a system for electronically delivering to a caregiver analytical alert data concerning a breach of an alert limit for an analyte. The system includes a medical analyzer with at least one threshold value for the at least one analyte to be sensed by the medical analyzer and a processor programmed to provide, if the sensed analyte level is beyond the threshold value, data comprising an indication of a breach of the threshold value, the degree of the breach on the basis of an amount over or under the threshold value, a time interval between breaches, a number of total breaches in a given time cycle, and the total number of tests in the time period. A communication module is provided for electronically sending the data to the caregiver, and a communication receiver is provided for receiving the data.

### BRIEF DESCRIPTION OF THE DRAWINGS

The FIGURE is a view showing the system of the present invention.

### DETAILED DESCRIPTION OF THE PREFERRED EMBODIMENTS

The present invention provides a method of presenting data from a medical analysis device, such as a bodily fluid analyzer or device that measures biomarkers without reference to bodily fluids per se such as a device for measuring cardiac function, to a user. This invention provides a system for managing data and alerts to a caregiver based upon data from a medical analysis device, e.g. and without limitation, a bodily fluid analyzer. This invention utilizes both Structural Metadata, or data about the “containers” of the data as well as Descriptive Metadata, which is the data content itself.

### Presenting Data From a Bodily Fluid Analyzer to a User

As noted, the commercial deployment of bodily fluid analyzers in the home or workplace will lead to massive amounts of data which must be presented in a manner which is novel when compared to the typical SMAC readout. Unlike the data involved in the use of these analyzers for drug trials, in which the important factors will be and are directed to a determination and amalgamation of data from many patients and many analyzers to determine factors like the therapeutic index, in this invention we are concerned with the presentation format of data to the caregiver on a given patient with real time, possibly daily (or other interval based) reports, of analyte data. This is akin to receiving SMAC data every day on each patient and calls for a novel way of presenting data so as not to incapacitate the care giver with a data overload.

The generation of alerts when a measurement exceeds (or falls below) a threshold level is understood (see e.g. Say US 2004/0106859A1 and Fuisz U.S. Pat. No. 7,824,612, each of which is incorporated by reference). Similarly as noted above, glucose measurements are sufficiently well-spaced, easily understood and typically taken in a single analyte context (i.e. a personal glucose monitor that only measures glucose levels), that the data output of such devices has not required but could include the present inventive step. For example, the data output of Bayer's Glucofacts system is described in Bayer's GLUCOFACTS® DELUXE Software User Guide, Rev. 1/10, © 2009 Bayer HealthCare LLC (see, http://www.bayercontour.com/resources/pdf/User-Guides/Glucofacts-Deluxe-User-Guide?ext=.pdf)(see particularly pp 8-11), which is incorporated by reference in its entirety.

### Frequency of Testing

The invention expressly contemplates that a physician, drug company or other authority may program an analyzer for frequency of testing through the use of a data storage unit, as that term is described in incorporated U.S. Pat. No. 7,824,612 (e.g. once per day, many times per day, every second day, every third day, etc or every week, etc. or every month, etc and so on, and including any other frequency or cycle combined with and varying relative to the chosen analyte). Other methods of programming an analyzer that do not employ a data storage unit and corresponding data reader (as described in U.S. Pat. No. 7,824,612) may also be used. In the beginning, this frequency of analysis will be somewhat of a trial and error effort as there is no real evidence, outside of pharmaceutical company new drug therapeutic index measurement, that demonstrates how frequent an interval will be used or useful for measurement of a given analyte. Cost factors for reagents will also be a consideration for frequency as well as the cost factors for such things as multi array or other type cartridges. For our purposes it is best to assume very frequent testing as that involves a real challenge to the analyzer/patient/data/caregiver relationship.

### Intelligent Alerts

Intelligent Alerts in this invention include the following non limiting factors:
a. The name of the analyte or biomarker
b. The breaches of an alert limit, whether a default or custom set by the caregiver.
c. The degree of the breach, i.e. up to 5%, over 5 to 10%, over 10% above the threshold (in the case of a maximum threshold) or below (in the case of a minimum threshold).
d. The time interval between the breaches (if more than one breach).
e. The total number of breaches in a given time cycle (best viewed on a rolling basis)
f. The total number of tests in that time period for that analyte or as some would say that biomarker.

In a preferred aspect of the invention, the Intelligent Alerts also include a mathematical relationship between at least the total number of breaches and the number of tests in the time cycle, and, more preferably, a mathematical relationship among the total number of breaches, the number of tests in the time cycle, and time interval between the breaches.

Data can be collected and transmitted on a fixed time period basis or on a rolling time period basis. Whether on fixed or rolling basis, data may be collected on an hourly, daily, weekly, monthly or annual basis. An indication of whether the data that has been collected and transmitted is on a fixed time period basis or on a rolling time period basis can be provided with the Intelligent Alerts to the caregiver, e.g., by providing the designation “f” for fixed or “r” for rolling.

The awareness of the breaches from the standpoint of trend formation is an interpretive decision which must be made by the caregiver upon close examination of the data presented in a clear manner.

For example, if potassium is measured every second day, and an alert of category one magnitude (e.g. a breach of 3% over the threshold value) occurs with an interval of fifteen days in between this is less concerning and would not necessarily constitute a trend. There would be many non-breach tests in between. A test done less frequently, say a hematocrit each fifteenth day, would thus form a worrisome trend even at a category 1 breach (up to 5% over the threshold value). It is a parameter not expected to change often, which is why the longer interval between tests is appropriate.

A category 2 breach would be over 5% to10% breach and it thus more concerning regardless of factors.

Those schooled in the cart will understand that under numeric/percentage breach categories may also be designated and used (i.e. different from the numerical ranges presented above).

While many of these breaches would call up for an instant alert to the care giver from the analyzer as in the U.S. Pat. No. 7,824,612, we are here looking at the overall interval data as presented to the caregiver so that the caregiver can grasp significant breaches and possible trends. This is not the only or limited way of presenting this data; however, the presence or influence of a) through f) is a necessity in order to put the large amounts of anticipated data in a perspective that it can be used in healthcare. There may be a tendency to look at analyte data in a manner similar to Oracle consumer data; however, this is dynamic data and the physician can never relinquish his judgment to an algorithmic analysis of this data in which a clinical judgment is made for him. Even with the nonlimiting Intelligent Fuisz Index described below, it still behooves the caregiver to look at the presentation of the data. That is the core of the novelty here: by elucidating in an easy to read manner a) through f), the Caregiver has an efficient comprehension of the potentially vast data generated.

The above is quite different from the basic metabolic panel that is provided by standard one time testing on blood from a physician visit. The example below shows the data tested and presented in a sample basic metabolic panel.

As noted below, testing frequency may also be impacted by cost of testing.

Additional factors need be employed by the rxclinician, including the (g) existence of a meaningful upward or downward trend with respect to a given analyte.

Thus the invention provides a method and system for automatically and electronically providing a caregiver with analytical alert data including the name of the analyte or biomarker, the breaches of an alert limit, whether a default or custom set by the caregiver, the degree of the breach, the time interval between the breaches, the number of total breaches in a given time cycle, and the total number of tests in the time period. The Intelligent Fuisz alert feature may, but does not necessarily, employ an index, which we will identify as the Intelligent Fuisz Index. The temporal index equals the total number of tests*the temporal span between breached tests divided by the number of outliers (breaches). Therefore, if two outliers in one month of daily testing occur, such outliers occurring ten days apart, the temporal index would be (30*10)/2=150.

If four outliers in one month of daily testing, occurring four days apart, the temporal index would be (30*4)/4=30.

If eight outliers in one month of daily testing, occurring three days apart, the temporal index would be(30*3)/8−11.12. The lower the Temporal Index, the more disturbing the result is relative to the individual patient

One must also keep in mind the notification of alerts that are inherent in the U.S. Pat. No. 7,824,612 that has been incorporated here. Those alerts may in some cases result in an alteration of the alert levels set by the caregiver. This novel approach need be thought of as the next step of U.S. Pat. No. 7,824,612, the handling of the data for the Physician. This responsibility can never be abdicated to a third party algorithm. If that were the case then the algorithm would become the physician. The exception to this is the pharma company determining the Therapeutic Index for a new chemical entity (NCE).

The term bodily fluid analyzer is used in this specification. The present invention is not limited to analyzers that measure bodily fluid, but may include all measurements of metabolic and physiologic indicia or other analytes.

The FIGURE shows a non-limitative embodiment of the system of the present invention. The system allows for electronically delivering to a caregiver analytical alert data concerning a breach of an alert limit for an analyte. The system includes a medical analyzer 1 with at least one threshold value for the at least one analyte to be sensed by the medical analyzer. The analyzer 1 is connected to a processor 2 programmed to provide, if the sensed analyte level is beyond the threshold value, data comprising an indication of a breach of the threshold value, the degree of the breach on the basis of an amount over or under the threshold value, a time interval between breaches, a number of total breaches in a given time cycle, and the total number of tests in the time period. The processor 2 may be resident on the analyzer (and may be the same processor as or a separate processor from the processor performing the analyzer functions) or may be provided separately therefrom. If provided separately, the processor 2 may be connected to the analyzer in any way that allows transfer of data from the analyzer to the processor, and the connection can be a wired connection, a wireless connection, a LAN connection, the Internet, etc. A communication module 3 is for electronically sending the data to the communication receiver 4 of the caregiver. The communication module 3 may be part of the analyzer 1 or the processor 2 and can take any form that would be known to those skilled in the art. The communication module can transmit the data to the communication receiver 4 of the caregiver through network 5, e.g., the Internet.

Non-limitative examples of the present invention is described below.

### EXAMPLE

### Metabolic Panel, Basic

Comments from Physician's Office

### Component Results

| | | | |
|---|---|---|---|
| Components | Your Value | Standard Range | Units |

| | | |
|---|---|---|
| Sodium | 136-145 | nmol/L |
| Potassium | 3.5-5.2 | nmol/L |
| Chloride | 101-110 | Nmol/L |
| Carbon Dioxide | 21-31 | mEq/L |
| Glucose | 83-110 | Mg/dl |
| Urea Nitrogen | 8-26 | Mg'dL |
| Creatinine | .7-1.3 | Mg/dL |
| eGFR | >60 | |
| eGFR | >60 | |
| AfricanAmerican | | |
| Calcium Serum | 8.8-10.6 | Mg/dL |

A Fuisz Alert data presentation sample schema:

K (the analyte measured and the limits set) 1(interval between testing in days-thus every day here) 30 (interval of measurement in days, fixed(F) or rolling(R)) 4 (number of breaches of alert levels set by caregiver) 6.0, 5.8(3), 5.9(4).5.8(6) (breach amounts followed by testing day of occurrence. Trend potential. Judged by caregiver here.

To the physician monitoring this patient on a home analyzer with limits set by that caregiver, this information would appear as follows:

K(4.0 to 4.8) 1 30(F Or R) 4 5.0, 4.9(3) 4.9(4) 4.9(6) Thus a Caregiver could use this Fuisz Alert to quickly ascertain if he saw a trend evolving or if he saw the K fall back to normal and make a judgment it was not a trend. Perhaps he might use the system taught in U.S. Pat. No. 7,824,612 to, at the next visit to add a creatinine test to the analyzer to ascertain renal function status.

If the Fuisz Trend Index were applied here the result would be:

30×6=180/6=30 Thirty would be a low enough temporal index to arouse suspicion.

Let us take the same patient and say they breached twice with a 12 day interval between breaches:

30×12=360/2=180 there is less concern here of a trend.

Now let us take a test which would be, in most cases more infrequently performed by a home analysis. The hematocrit, if the analyzer has this accurate ability. Let us say it is done on a rolling every 30 day basis and that it dropped from 40 to 38. This would appear as:

### Readout:

HCT 30 30 1(38)

1×30=30/1=30 cause for suspicion and here a possible down trend.

It is important to note that this invention provides data to a caregiver that is provided in addition to alerts sent from an analyzer, e.g., in accordance with the method and system described in and Fuisz U.S. Pat. No. 7,824,612. That is, the data provided by the present invention does not supplant the alerts as called for in and Fuisz U.S. Pat. No. 7,824,612, but rather is cumulative data that is a concise and effective data summary that should be supplied to the Caregiver in addition to the alerts of and Fuisz U.S. Pat. No. 7,824,612.

In another aspect of the invention, the overall day-to-day data assigned by the physician or pharma company to a specific drug will be accrued on a Hippa complaint registration basis. If this data is then used to the benefit of any other entity other than the patient, this data will be used to make a micro payment to the patient for their data usage. The amount of the micro payment would be broadly, but not limited, related to the total data volume used divided by the individual's data inclusion. The metadata should have a registration of patient. The patient's medical data should not be profiteered by selling it without that sale having substantive monies returned to the data source, the patient.

1. A method for electronically delivering to a caregiver analytical alert data concerning a breach of an alert limit for an analyte, comprising:
programming a medical analyzer device with at least one threshold value for the at least one analyte to be sensed by the medical analyzer device;
sensing the analyte level; and
electronically sending structural metadata to the caregiver, the structural metadata comprising an indication of the analyte and the limits set by the caregiver, a breach of the threshold value, the degree of the breach on the basis of an amount over or under the threshold value, a time interval between breaches whether fixed or rolling, a total number of breaches in a given time cycle, and the total number of tests in the time period.

2. (canceled)

3. The method according to claim 1, further comprising gathering data in a HIPAA compliant manner from a plurality of patients relating to a common drug being taken, common disease or common course of treatment, providing the gathered data to a third party, and providing compensation to at least one of the patients.

4. A system for electronically delivering to a caregiver analytical alert data concerning a breach of an alert limit for an analyte, comprising:
a medical analyzer with at least one threshold value for the at least one analyte to be sensed by the medical analyzer;
a processor programmed to provide, if the sensed analyte level is beyond the threshold value, structural metadata comprising an indication of a breach of the threshold value, the degree of the breach on the basis of an amount over or under the threshold value, a time interval between breaches, a number of total breaches in a given time cycle, and the total number of tests in the time period;
a communication module for electronically sending the structural metadata to the caregiver; and
a communication receiver for receiving the structural metadata.

5. The system according to claim 4, further comprising a data storage unit provided separately from the medical analyzer and containing stored information set by a prescribing physician or a drug company and including the at least one threshold value of at least one analyte to be sensed by the medical analyzer, the at least one threshold value of the at least one analyte being associated with a particular drug being or to be taken by the patient or course of treatment for the patient.

6. The method according to claim 1, wherein programming the medical analyzer comprises selecting by a prescribing physician or a drug company the at least one threshold value of at least one analyte to be sensed by the medical analyzer, the at least one threshold value of the at least one analyte being associated with a particular drug being or to be taken by the patient or course of treatment for the patient, providing a data storage unit separately from the medical analyzer and containing stored information including the at least one threshold value of at least one analyte to be sensed by the medical analyzer selected by the prescribing physician or the drug company; reading the stored information stored on the data storage unit into a data reader associated with a medical analyzer, and setting the medical analyzer with the at least one threshold value for the at least one analyte to be sensed by the medical analyzer with the information read by the data reader from the data storage unit.
